(19) United States
(12) Patent Application Publication
(10) Pub. No.: US 2014/0372930 A1
(43) Pub. Date: Dec. 18, 2014

(54) METHOD AND DEVICE FOR DISPLAYING A LIST VIEW THROUGH A SLIDING OPERATION

(71) Applicant: TENCENT TECHNOLOGY (SHENZHEN) COMPANY LIMITED, Shenzhen City (CN)

(72) Inventor: Yanchao LI, Shenzhen City (CN)

(73) Assignee: TENCENT TECHNOLOGY (SHENZHEN) COMPANY LIMITED, Shenzhen City (CN)

(21) Appl. No.: 14/259,863

(22) Filed: Apr. 23, 2014

Related U.S. Application Data
(63) Continuation of application No. PCT/CN2013/089066, filed on Dec. 11, 2013.

(30) Foreign Application Priority Data
Jun. 13, 2013 (CN) 201310233852.0

(51) Int. Cl. G06F 3/0482; G06F 3/0488; G06F 3/0485

(52) U.S. Cl. CPC G06F 3/0482; G06F 3/0485; G06F 3/0488
USPC 715/772

(57) ABSTRACT

Provided is a method for displaying a list view through a sliding operation, including: acquiring a triggering event of progress bar; acquiring a list view corresponding to said triggering event of progress bar; reading a dynamically set location configuration of progress bar corresponding to said list view, and said location configuration of progress bar contains either one of a left-align attribute and a right-align attribute; and displaying a progress bar of said list view according to said location configuration of progress bar. Further provided is a device for displaying a list view through a sliding operation. The method and device for displaying a list view through a sliding operation herein can facilitate the operation.

This application is a continuation application of PCT Patent Application No. PCT/CN2013/089066, entitled “METHOD AND DEVICE FOR DISPLAYING A LIST VIEW THROUGH A SLIDING OPERATION” filed on Dec. 11, 2013, which claims priority to Chinese Patent Application No. 201310233852.0, entitled “METHOD AND DEVICE FOR DISPLAYING A LIST VIEW THROUGH A SLIDING OPERATION” filed on Jun. 13, 2013, both of which are incorporated by reference in their entirety.

### TECHNICAL FIELD

The present disclosure relates to the field of mobile internet technology, and more particularly to a method and device for displaying a list view through a sliding operation.

### BACKGROUND OF THE INVENTION

A list view, namely ListView component, is an interface displaying component configured to display list items in IOS system or Android system (both in IOS and Android, the name of a list view component is ListView), for example, various kinds of lists such as a contact list, a micro-blog list, a SMS list, and so on, are displayed through list views. A progress bar is set on the right sidebar of a list view, and a user can locate a list item through sliding a slider disposed on the progress bar.

With regard to a large-screen mobile phone, when a user operates the mobile phone with left hand one-handedly, the user is not able to touch the slider of the progress bar since the screen is too wide; therefore, the user has to use both hands to complete the sliding operation, which is inconvenient to operate.

### SUMMARY OF THE INVENTION

In view of defects existing in the conventional method, in one aspect, the present disclosure provides a method for displaying a list view through a sliding operation so as to facilitate the operation:

A method for displaying a list view through a sliding operation, includes:

acquiring a triggering event of progress bar;

acquiring a list view corresponding to said triggering event of progress bar;

reading a dynamically set location configuration of progress bar corresponding to said list view, and said location configuration of progress bar contains either one of a left-align attribute and a right-align attribute; and

displaying a progress bar of said list view according to said location configuration of progress bar.

In another aspect, the present disclosure provides a device for displaying a list view through a sliding operation:

A device for displaying a list view through a sliding operation, includes:

an event acquiring module, configured to acquire a triggering event of progress bar;

a component acquiring module, configured to acquire a list view corresponding to said triggering event of progress bar;

a configuration reading module, configured to read a dynamically set location configuration of progress bar corresponding to said list view, and said location configuration of progress bar contains either one of a left-align attribute and a right-align attribute; and

an interface displaying module, configured to display a progress bar of said list view according to said location configuration of progress bar.

According to the method and device for displaying a list view through a sliding operation mentioned above, after a triggering event of progress bar corresponding to the list view is acquired, an alignment attribute (such as a left-align attribute or a right-align attribute) contained in the location configuration of the progress bar is read; the location of the progress bar in the displaying interface is set according to said alignment attribute, so that the user can select to display the progress bar either on the left sidebar or right sidebar of the list view by means of presetting the alignment attribute contained in the configuration file or dynamically setting the alignment attribute contained in the configuration file after the list view is loaded. With regard to a large-screen mobile phone or a tablet PC, either in left-hand mode or right-hand mode, the user can quickly slide the list view to locate list items only with one hand, which facilitates the operation.

### BRIEF DESCRIPTION OF THE DRAWINGS

FIG. 1 is a flow diagram illustrating the method for displaying a list view through a sliding operation according to one embodiment of the present invention;

FIG. 2 is a diagram illustrating an operating interface of a list view in a mobile phone according to one embodiment of the present invention;

FIG. 3 is a diagram illustrating an operating interface of a list view in a mobile phone according to another embodiment of the present invention;

FIG. 4 is a diagram illustrating operating interfaces of a list view in a mobile phone according to another embodiment of the present invention;

FIG. 5 is a diagram illustrating operating interfaces of a list view in a mobile phone according to another embodiment of the present invention;

FIG. 6 is a diagram illustrating operating interfaces of a list view in a mobile phone according to another embodiment of the present invention;

FIG. 7 is a structure diagram illustrating the device for displaying a list view through a sliding operation according to one embodiment of the present invention;

FIG. 8 is a structure diagram illustrating the terminal for displaying a list view through a sliding operation according to another embodiment of the present invention.

### DETAILED DESCRIPTION OF THE EMBODIMENTS

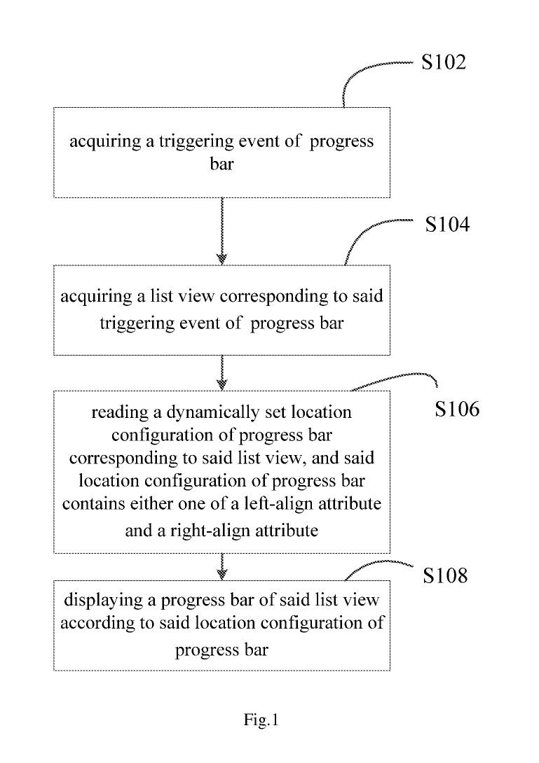

In one embodiment as shown in FIG. 1, a method for displaying a list view through a sliding operation is provided, and said method entirely relies on computer programs, said computer programs can be operated in a mobile terminal based on Von Neumann architecture, such as a mobile phone, a tablet PC, a laptop, a pocket PC, an e-Reader, and so on. Said method includes following steps:

S102, acquiring a triggering event of progress bar.

In one embodiment, the triggering event of progress bar is an event that triggers a progress bar of list view to be displayed. The progress bar of list view may be displayed immediately after the list view is loaded (that is, once the list view is created, the progress bar thereof is visible all the time), or may be displayed when a triggering operation by a user is acquired after the list view has been loaded. If the triggering operation by the user is time-out, the progress bar of list view can be automatically hidden, so that the display space will be utilized more reasonably.

For example, a triggering event of progress bar may be a loading completed event of list view, after the loading of list view has been completed, the loading completed event is triggered, and the progress bar of list view is notified to be displayed; alternatively a triggering event of progress bar may be a sliding input event, when a user executes an operation of sliding input on a list view, such as a contact list, a SMS list, and so on, the corresponding progress bar of list view is notified to be displayed; alternatively a triggering event of progress bar may be a button triggering event, when a user presses down a function button, the progress bar of list view is notified to be displayed.

S104, acquiring a list view corresponding to said triggering event of progress bar.

If a triggering event of progress bar is a loading completed event, then the corresponding list view loaded, which induced said loading completed event, is acquired; if a triggering event of progress bar is a sliding input event, then the display area where the triggering event of progress bar locates is acquired and the list view corresponding to said display area is acquired.

S106, reading a dynamically set location configuration of progress bar corresponding to said list view, and said location configuration of progress bar contains either one of a left-align attribute and a right-align attribute.

S108, displaying a progress bar of said list view according to said location configuration of progress bar.

The list view has a corresponding configuration file for defining an interface pattern, said configuration file may be pre-set in the attribute setting of the mobile phone, or may be dynamically set through configure functions after the list view has been loaded. In this embodiment, the configuration file is set by means of reading the location configuration of progress bar: judging whether the alignment attribute contained in said location configuration of progress bar is a left-align attribute or a right-align attribute, if said alignment attribute herein is the left-align attribute, then displaying the progress bar on the left sidebar of the displaying interface of the list view; and if said alignment attribute herein is the right-align attribute, then displaying the progress bar on the right sidebar of the displaying interface of the list view.

For example, in the Android system, the pattern configuration file of list view is xml file format. Wherein, the alignment attribute is layout_alignParentLeft, if the alignment attribute is set to be left, then the alignment attribute being read is the left-align attribute, that is, the progress bar is displayed on the left sidebar; and if the alignment attribute is set to be right, then the alignment attribute being read is the right-align attribute, that is, the progress bar is displayed on the right sidebar.

In one embodiment, the step of displaying a progress bar of said list view according to said location configuration of progress bar further includes following sub-steps: acquiring a sort index of list view; and displaying a scale value, corresponding to said sort index, on said progress bar.

The sort index of list view refers to an index value configured to sort the list items of a list view.

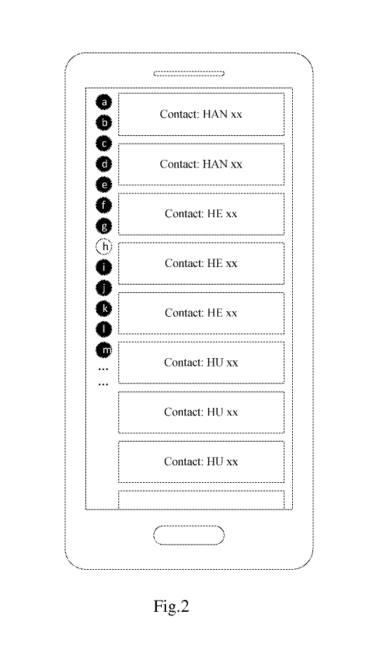

As shown in FIG. 2, in a list view corresponding to a contact list, the sort index is an alphabet sort index, that is, an index of sorting according to the sequence of initial letters of contact names or initial letters of pinyin corresponding to contact names in an alphabet. A scale value with 26 letters can be displayed in sequence on the progress bar.

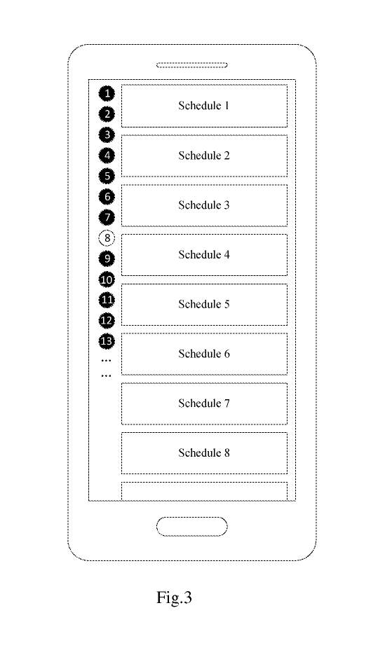

As shown in FIG. 3, in a list view corresponding to a to-do list application, which refers to that a user can add multiple tasks to be handled and the handling time thereof into said application and the application reminds the user when the handling time is reached, the sort index may be a chronological sequence sort index, which is an index of sorting according to the sequence of handling time corresponding to the list items. A scale value with 0-23 or 0-11 am and 0-11 pm may be displayed in sequence on the progress bar.

In one embodiment, after the step of displaying a progress bar of said list view according to said location configuration of progress bar, the progress information of display location of list view can be further acquired, and a slider is displayed on said progress bar according to said progress information of display location.

As shown in FIG. 4, the slider may be in the shape of a scroll bar, a dot, a block or an icon, furthermore, as shown in FIG. 2 and FIG. 3, the slider may be a highlighted scale value (please refer to the scale value 8 shown in FIG. 2 and the scale value h shown in FIG. 3).

The progress information of display location of list view refers to the relative location of the current list item on the display interface among all list items sorted in sequence. The corresponding percentage of length of the slider on the progress bar can be determined according to said relative location.

Furthermore, after the step of displaying a slider on said progress bar according to said progress information of display location, a locating event corresponding to said slider and said progress bar is acquired, the locating progress information of said locating event on said progress bar is acquired, and said list view is displayed according to said locating progress information.

The locating progress information refers to the relative location of the located item among the sorted list items, which can be represented in percentage.

In one embodiment, the locating event may be a sliding event. The sliding operation by a user to said slider can be acquired so as to acquire the sliding distance of said slider in the direction of extension of the progress bar; the locating progress information can be acquired according to said sliding distance and the length of the progress bar; and according to said locating progress information, the corresponding list item in the list view is acquired and displayed.

In one embodiment, the locating event may be a touching event. The touching event of the progress bar can be acquired so as to acquire the relative location of the touch point, corresponding to the touching event, on the progress bar. If the slider is a dot, a block or an icon, and so on, said slider is slid to the touch point on the progress bar so as to be displayed, and the locating progress information is the relative location of the touch point on the progress bar; if the slider is a scale value, the scale value corresponding to said touch point is acquired and highlighted, and the locating progress information is the relative location of the scale value in the sort index.

By means of locating the display location of the list view with the slider, if there are large amount of list items, the display location of the list view can be quickly moved to the corresponding list item through a locating operation with the slider on the progress bar, which facilitates the operation.

In one embodiment, the input information of location configuration of progress bar can be acquired, and saved into a configuration file.

In one embodiment, the entrance of location configuration of progress bar can be displayed on the setting interface of the mobile phone. A user can access the location configuration by selecting “mobile phone setting”, and in the “left/right-hand mode” option, the user can select the left-hand mode or the right-hand mode through sliding the slider. The left-hand mode means that the progress bar of the list view is displayed on the left sidebar, and the right-hand mode means that the progress bar of the list view is displayed on the right sidebar. The “left-hand mode” or “right-hand mode” is information of the location configuration of progress bar. The configuration file to be saved is the pattern configuration file of list view. For example, in the Android system, the “left-hand mode” corresponds to the “left” attribute value of the layout_alignParentLeft in xml file, and the “right-hand mode” corresponds to the “right” attribute value.

In one embodiment, the input information of location configuration of progress bar can be acquired through triggering an instruction. In one application scenario, a sliding event corresponding to said progress bar and perpendicular to the direction of extension of the progress bar can be acquired, and the input information of location configuration of progress bar can be acquired through triggering an instruction. Furthermore, when said input information of location configuration is saved into the configuration file, the list view is re-drawn so as to adjust the location of the progress bar on the display interface at real time.

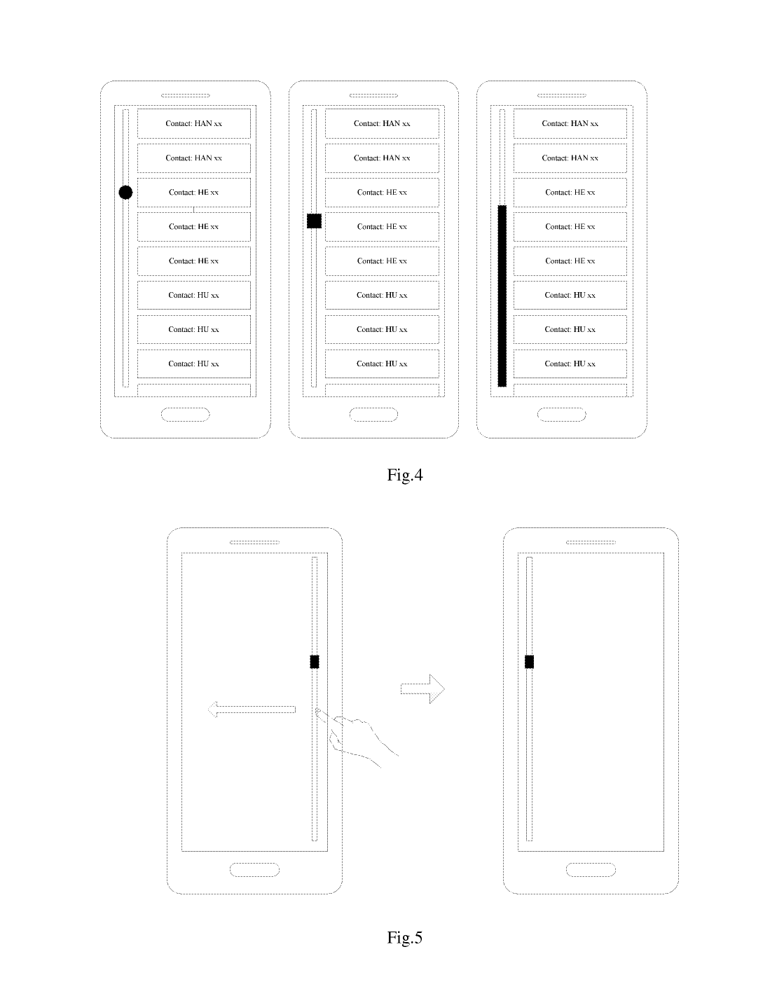

For example, as shown in FIG. 5, the initial location of the progress bar is located on the right sidebar of the list view, if a user presses on the progress bar and slides said progress bar for a certain distance towards the left horizontally, said progress bar will be displayed on the left sidebar through modifying and re-drawing the configuration file.

In another application scenario, a toggle key of left/right-hand mode can be set, and the display location of the progress bar can be switched through triggering said toggle key of left/right-hand mode.

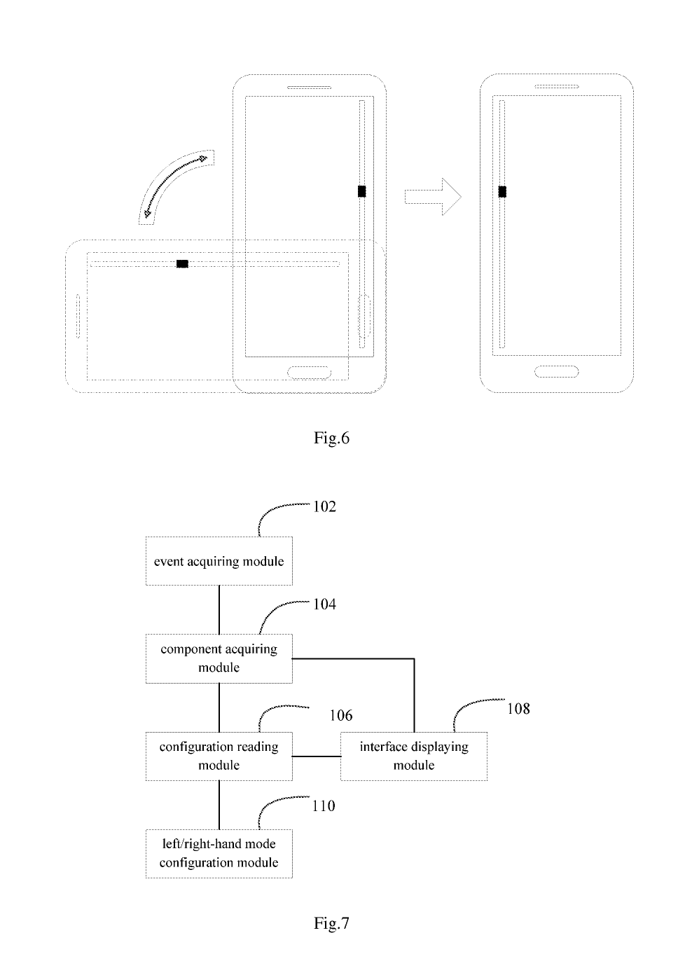

In another application scenario, the display location of progress bar can be switched through rotating the mobile phone. As shown in FIG. 6, if the user rotates the mobile phone 90 degrees to the left and then returns quickly, the information of location configuration of progress bar corresponding to the left-hand mode will be input; and if the user rotates the mobile phone 90 degrees to the right and then returns quickly, the information of location configuration of progress bar corresponding to the right-hand mode will be input.

In one embodiment as shown in FIG. 7, a device for displaying a list view through a sliding operation is provided, including:

an event acquiring module 102, configured to acquire a triggering event of progress bar;

a component acquiring module 104, configured to acquire a list view corresponding to said triggering event of progress bar;

a configuration reading module 106, configured to read a dynamically set location configuration of progress bar corresponding to said list view, and said location configuration of progress bar contains either one of a left-align attribute and a right-align attribute; and

an interface displaying module 108, configured to display a progress bar of said list view according to said location configuration of progress bar.

In one embodiment, said interface displaying module 108 is further configured to acquire a sort index of list view; and display a scale value, corresponding to said sort index, on said progress bar.

In one embodiment, said interface displaying module 108 is further configured to acquire progress information of display location of list view; and display a slider on said progress bar according to said progress information of display location.

In one embodiment, said interface displaying module 108 is further configured to acquire a locating event corresponding to said slider and said progress bar; acquire locating progress information of said locating event on said progress bar; and display said list view according to said locating progress information.

In one embodiment as shown in FIG. 7, the device for displaying a list view through a sliding operation further includes a left/right-hand mode configuration module 110, configured to acquire input information of location configuration of progress bar; and save said information of location configuration of progress bar into a configuration file.

According to the method and device for displaying a list view through a sliding operation mentioned above, after a triggering event of progress bar corresponding to the list view is acquired, an alignment attribute (such as a left-align attribute or a right-align attribute) contained in the location configuration of the progress bar is read; the location of the progress bar in the displaying interface is set according to said alignment attribute, so that the user can select to display the progress bar either on the left sidebar or right sidebar of the list view by means of presetting the alignment attribute contained in the configuration file or dynamically setting the alignment attribute contained in the configuration file after the list view is loaded. With regard to a large-screen mobile phone or a tablet PC, either in left-hand mode or right-hand mode, the user can quickly slide the list view to locate list items only with one hand, which facilitates the operation.

It should be understood by those skilled in the art that all or part of the processes of preferred embodiments disclosed above may be realized through relevant hardware commanded by computer program instructions. Said program may be saved in a computer readable storage medium, and said program may include the processes of the preferred embodiments mentioned above when it is executed. Wherein, said storage medium may be a diskette, an optical disk, ROM (Read-Only Memory) or RAM (Random Access Memory), and so on.

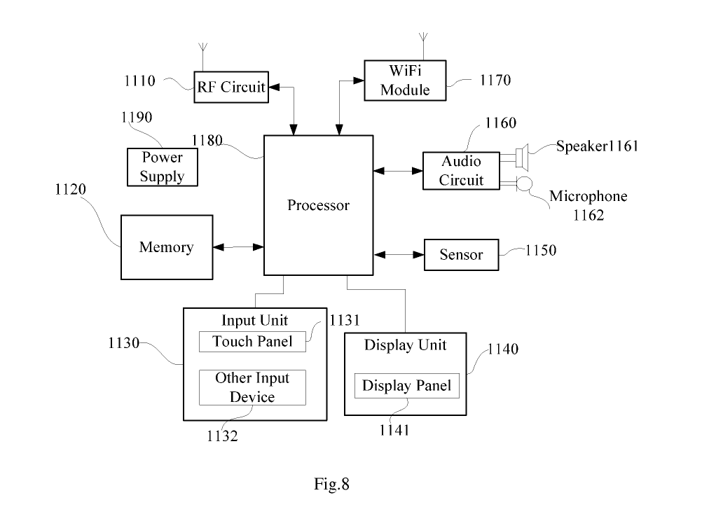

In one embodiment as shown in FIG. 8, a terminal for displaying a list view by a triggering operation is provided. In order to illustrate said terminal more clearly, what is shown in FIG. 8 is a part of said terminal relevant to this embodiment of the present invention, for the technical details which are uncovered, please refer to embodiments involving methods of the present invention. Said terminal may be any terminal devices such as a mobile phone, tablet PC, PDA (personal digital assistant), POS (point of sales), on-board computer, and so on. A mobile phone, a mobile terminal, will be taken as an example.

FIG. 8 is a structure diagram illustrating a portion of a mobile phone relevant to the terminal for displaying a list view by a triggering operation according to one embodiment of the present invention. As shown in FIG. 8, the mobile phone includes: RF (Radio Frequency, RF) circuit 1110, a memory 1120, an input unit 1130, a display unit 1140, a sensor 1150, an audio circuit 1160, a communication unit, such as a wireless fidelity (wireless fidelity, Wi-Fi) module 1170 or other types of communication unit, a processor 1180, a power supply 1190 and so on. It should be understood by those skilled in the art that, the mobile phone is not limited by the structure of the mobile phone shown in FIG. 9, but may include more or less components, or any combinations thereof, or the components may be arranged in different layouts.

Various components of the mobile phone will be described in more details with reference to the FIG. 8:

RF circuit 1110 is used to send and receive signals in process of sending and receiving messages or making phone calls, preferably, after receiving downlink information from a base station, the RF circuit 1110 sends said downlink information to the processor 1180 for processing; on the other hand, the designed uplink data is sent to the base station. Usually, the RF circuit includes but is not limited to, an antenna circuitry, at least one amplifier, a transceiver, a coupler, a low noise amplifier (LNA), a duplexer, and so on. Moreover, the RF circuit 1110 may also communicate with other devices through wireless communication and network. The wireless communication mentioned above may use any communication or agreement which includes but is not limited to GSM (Global System for Mobile Communications), GPRS (General Packet Radio Service), CDMA (Code Division Multiple Access), WCDMA (Wideband Code Division Multiple Access), LTE (Long Term Evolution), e-mail, SMS (Short Messaging Service), and so on.

The memory 1120 is used for saving software programs and modules; the processor 1180 executes various functions of the mobile phone and data processing applications by running said software programs and modules saved in the memory 1120. Memory 1120 may mainly include a program storage area and a data storage area, wherein, said program storage area may store an operating system program, application program required by at least one function (such as sound playback, image playback, etc.), and so on; said data storage area may store data created according to the usage of the mobile phone (such as audio data, phone book, etc.). In addition, said memory 1120 may include a high-speed random access memory, and may further include a non-volatile memory, such as at least one of disk storage devices, flash memory devices and other volatile solid state memory devices.

Said input unit 1130 is used for receiving numbers or character information entered by the user, and for generating key signal inputs relevant to user settings and function control of the mobile phone 1100. Particularly, said input unit 1130 may include a touch panel 1131 and other input devices 1132. Said touch panel 1131, also known as a touch screen, is used for collecting the user's touch operations thereon or nearby (for example, a user operates on or near said touch panel 1131 using a finger, a stylus, and any other suitable objects or attachments), and driving corresponding connecting devices based on a preset program. Preferably, said touch panel 1131 may include a touch detection unit and a touch controller. Wherein the touch detection unit detects the touch position of the user, and detects signals generated by the touch operation, and then the signals are sent to a touch controller; the touch controller receives the touch information from said touch detection unit and converts said touch information into contact coordinates, and then sends said contact coordinates to said processor 1180, said touch controller is also able to receive instructions from said processer 1180 and execute said instructions. Wherein, said touch panel 1131 may be realized in various manners such as resistance-type, capacitance-type, infrared-ray and surface acoustic wave. In addition to said touch panel 1131, said input unit 1130 may further include other input device 1132. Particularly, said other input device 1132 includes but is not limited to one or more of a physical keyboard, function keys (such as volume control buttons, switch buttons, etc.), a trackball, a mouse and an operating lever.

Said display unit 1140 is used for displaying the information entered by a user or information provided to a user as well as various menus of the mobile phone. Said display unit 1140 may include a display panel 1141, particularly, said display panel 1141 may be configured by a LCD (Liquid Crystal Display), an OLED (Organic Light-Emitting Diode) or other forms of display panel. Preferably, said touch panel 1131 covers said display panel 1141, after detecting a touch operation thereon or nearby, said touch panel 1131 generates a touch signal and sends said touch signal to said processor 1180 so as to determine the type of touch event, and then said processor 1180 provides a corresponding visual output on said display panel 1141 according to the type of touch event. Although in the embodiment shown in FIG. 9, said touch panel 1131 and said display panel 1141 are embodied as two separate components to achieve input and output functions of the mobile phone, in some embodiments, said touch panel 1131 and said display panel 1141 may be integrated to achieve input and output functions of the mobile phone.

The mobile phone 1100 may further include at least one sensor 1150, such as an optical sensor, motion sensor and other types of sensors. Particularly, the optical sensor may include an ambient light sensor and a proximity sensor, wherein, the ambient light sensor can adjust the brightness of the display panel 1141 according to the brightness of ambient light, and the proximity sensor can close said display panel 1141 and/or backlight when the mobile phone moves to the ear. As a motion sensor, accelerometer sensor can detect the value of acceleration in each direction (typically three axis), and can detect the magnitude and direction of gravity when it is in static state, and further can be used for applications involving identifying the phone posture (such as horizontal and vertical screen switching, related games, magnetometer calibration posture), vibration recognition related functions (e.g. pedometer, percussion), etc.; as for other sensors which may be equipped in the mobile phone, such as a gyroscope, barometer, hygrometer, thermometer, infrared sensor and so on, they will not be described here in details.

Said audio circuit 1160, speaker 1161, microphone 1162 can provide an audio interface between the user and the mobile phone. Said audio circuit 1160 can receive audio data and convert the audio data into electrical signals, and then transmit said electrical signals to said speaker 1161. Said speaker 1161 converts said electrical signals to audio signals to be output; on the other hand, said microphone 1162 converts sound signals collected to electrical signals, and after receiving said electrical signals the audio circuit 1160 converts said electrical signals to audio data, and outputs said audio data to the processor 1180 for processing, and then said audio data are sent to another phone via said RF circuit 1110, or sent to said memory 1120 for further processing.

Wi-Fi belongs to a short-range wireless transmission technology, and a mobile phone can help the user to send and receive email, browse the web and access streaming media, and so on via the Wi-Fi module 1170, which provides wireless broadband Internet access to the user. Although FIG. 9 shows a Wi-Fi module 1170, but it should be understood that it is not an essential part of said mobile phone 1100, but may be omitted as needed within the scope of unchanging the essence of the present invention.

Said processor 1180 is the control center of the mobile phone, used for connecting each part of the mobile phone through a variety of interfaces and connections, and executing various functions of the mobile phone and data processing to monitor the overall of the mobile phone by running or executing software programs and/or modules stored in the memory 1120 and calling in data stored in the memory 1120. Preferably, said processor 1180 may include one or more processing units; preferably, an application processor and a modem processor may be integrated in said processor 1180, wherein, said application processor mainly processes the operating system, user interface and applications, and said modem processor mainly deals with wireless communications. It should be understood that said modem processor mentioned above may be not integrated into said processor.

Said mobile phone 1100 further includes a power supply 1190 (such as a battery), used for supplying the power to various parts, preferably, said power supply system is logically connected to said processor 1180 via the power management system, thereby realizing functions such as charging management, discharging management, power consumption management, and so on via the power management system.

Although it is not shown, said mobile phone 1100 may further include a camera, Bluetooth module, etc., which are not discussed in details here.

It should be understood by those skilled in the art that what described above are preferred embodiments of the present invention. Various modifications and replacements may be made therein without departing from the theory of the present disclosure, which should also be seen in the scope of the present disclosure.

What is claimed is:

1. A method for displaying a list view through a sliding operation, comprising:
acquiring a triggering event of progress bar;
acquiring a list view corresponding to said triggering event of progress bar;
reading a dynamically set location configuration of progress bar corresponding to said list view, and said location configuration of progress bar contains either one of a left-align attribute and a right-align attribute; and
displaying said progress bar of said list view according to said location configuration of progress bar.

2. The method for displaying a list view through a sliding operation according to claim 1, wherein, said step of displaying said progress bar of said list view according to said location configuration of progress bar further comprises:
acquiring a sort index of said list view; and
displaying a scale value, corresponding to said sort index, on said progress bar.

3. The method for displaying a list view through a sliding operation according to claim 1, wherein, after said step of displaying said progress bar of said list view according to said location configuration of progress bar, said method further comprises:
acquiring progress information of display location of said list view; and
displaying a slider on said progress bar according to said progress information of display location.

4. The method for displaying a list view through a sliding operation according to claim 3, wherein, after the step of displaying a slider on said progress bar according to said progress information of display location, the method further comprises:
acquiring a locating event corresponding to said slider and said progress bar;
acquiring locating progress information of said locating event on said progress bar; and
displaying said list view according to said locating progress information.

5. The method for displaying a list view through a sliding operation according to claim 1, further comprising:
acquiring input information of location configuration of progress bar; and
saving said information of location configuration of progress bar into a configuration file.

6. The method for displaying a list view through a sliding operation according to claim 1, wherein, said method for displaying a list view through a sliding operation relies on computer programs and the computer programs are operated in a mobile terminal based on Von Neumann architecture.

7. A device for displaying a list view through a sliding operation, comprising:
an event acquiring module, configured to acquire a triggering event of progress bar;
a component acquiring module, configured to acquire a list view corresponding to said triggering event of progress bar;
a configuration reading module, configured to read a dynamically set location configuration of progress bar corresponding to said list view, and said location configuration of progress bar contains either one of a left-align attribute and a right-align attribute; and
an interface displaying module, configured to display a progress bar of said list view according to said location configuration of progress bar.

8. The device for displaying a list view through a sliding operation according to claim 7, wherein, said interface displaying module is further configured to acquire a sort index of said list view; and display a scale value, corresponding to said sort index, on said progress bar.

9. The device for displaying a list view through a sliding operation according to claim 7, wherein, said interface displaying module is further configured to acquire progress information of display location of said list view; and display a slider on said progress bar according to said progress information of display location.

10. The device for displaying a list view through a sliding operation according to claim 9, wherein, said interface displaying module is further configured to acquire a locating event corresponding to said slider and said progress bar; acquire locating progress information of said locating event on said progress bar; and display said list view according to said locating progress information.

11. The device for displaying a list view through a sliding operation according to claim 7, wherein, said device further comprises a left/right-hand mode configuration module, configured to acquire input information of location configuration of a progress bar; and save said information of location configuration of a progress bar into a configuration file.

12. The device for displaying a list view through a sliding operation according to claim 7, wherein, said device for displaying a list view through a sliding operation is based on a mobile terminal, and said mobile terminal is based on Von Neumann architecture.

13. The method for displaying a list view through a sliding operation according to claim 2, wherein, said method for displaying a list view through a sliding operation relies on computer programs and the computer programs are operated in a mobile terminal based on Von Neumann architecture.

14. The method for displaying a list view through a sliding operation according to claim 3, wherein, said method for displaying a list view through a sliding operation relies on computer programs and the computer programs are operated in a mobile terminal based on Von Neumann architecture.

15. The method for displaying a list view through a sliding operation according to claim 4, wherein, said method for displaying a list view through a sliding operation relies on computer programs and the computer programs are operated in a mobile terminal based on Von Neumann architecture.

16. The method for displaying a list view through a sliding operation according to claim 5, wherein, said method for displaying a list view through a sliding operation relies on computer programs and the computer programs are operated in a mobile terminal based on Von Neumann architecture.

17. The device for displaying a list view through a sliding operation according to claim 8, wherein, said device for displaying a list view through a sliding operation is based on a mobile terminal, and said mobile terminal is based on Von Neumann architecture.

18. The device for displaying a list view through a sliding operation according to claim 9, wherein, said device for displaying a list view through a sliding operation is based on a mobile terminal, and said mobile terminal is based on Von Neumann architecture.

19. The device for displaying a list view through a sliding operation according to claim 10, wherein, said device for displaying a list view through a sliding operation is based on a mobile terminal, and said mobile terminal is based on Von Neumann architecture.
